(19) United States
(12) Patent Application Publication
(10) Pub. No.: US 2003/0017802 A1
(43) Pub. Date: Jan. 23, 2003

(54) Method and apparatus for the preparation and broadcasting of audio and/or visual sequences

(75) Inventors: Romanelli Manlio, Trieste (IT); Comelli Leonardo, Trieste (IT)

Correspondence Address: Finnegan, Henderson, Farabow,, Garrett & Dunner, L.L.P., 1300 I Street, N.W., Washington, DC, 20005-3315, US

(73) Assignee: MEDIA TECHNOLOGIES SRL.

(21) Appl. No.: 10/191,294

(22) Filed: Jul. 10, 2002

(30) Foreign Application Priority Data
Jul. 10, 2001 (IT) UD2001A000118

(51) Int. Cl. H04H 1/00; H04H 7/00

(52) U.S. Cl. 455/3.06; 455/3.01

(57) ABSTRACT

Method and apparatus (10) for the preparation and broadcasting of audio and/or visual sequences by a user (12), which provides that a service center (11) prepares for the user (12), according to specific requests therefrom, a plurality of audio and/or visual documents in electronic format and transmits them telematically to the user (12) so that it can broadcast them by means of its own broadcasting systems (16, 17) according to a pre-set sequential pattern.

### FIELD OF THE INVENTION

The present invention concerns a method and an apparatus for the preparation and broadcasting of audio and/or visual sequences to be used preferentially, but not exclusively, in commercial enterprises in order to personalize the musical background, public announcements and advertizing, messages which are transmitted in such enterprises.

### BACKGROUND OF THE INVENTION

It is known the broadcasting of a musical background inside commercial enterprises, such as for example supermarkets, shopping centers, hyperstores, etc.

This broadcasting is often accompanied, or interrupted, by advertizing messages or public announcements which, if not properly programmed, may be annoying for the clientele, not very efficacious or even harmful.

Many commercial enterprises, in fact, broadcast the musical background by tuning in the audio transmission system to the frequency of a desired radio station, possibly superimposing its own promotional messages on the background.

This makes it necessary to entirely absorb the musical program of the chosen radio station, even though some musical genres may not be pleasant; above all, it entails the risk of broadcasting some advertizing messages, transmitted by the same radio station, which may be unwanted, for example because relating to activities or products of the competition.

Another problem is that, between one item and another, or for longer continuous periods, most radio stations broadcast dialogues or debates which interrupt the musical background.

Such interruptions, together with those needed to transmit personalized promotional messages, can annoy the customers, especially when they are listening to a particularly pleasant piece of music.

The above-mentioned disadvantages also occur when the commercial enterprises are equipped with screens on which images are transmitted which can be connected to the audio track, for example if there is a connection with a musical television station.

Another solution, adopted by some commercial enterprises, is to prepare musical supports (audiocassettes or CDs) on which the desired music is recorded, and possibly the promotional messages too, and which are broadcast in succession.

This solution, however, entails the need for a long work of selecting and recording the sequences, with limited opportunity of modifying them, to the disadvantage of the more frequent customers, and especially of the staff, who are subjected to listening to a “list” which is repeated periodically, unchanged even in the order of the music broadcast.

The Applicant has devised and embodied this invention to overcome these shortcomings of the state of the art, and to obtain further advantages.

### SUMMARY OF THE INVENTION

The present invention is set forth and characterized essentially in the main claims, while the dependent claims describe other innovative characteristics of the invention.

The purpose of the invention is to achieve a method and an apparatus for the preparation and broadcasting of audio and/or visual sequences which allow maximum personalization of these sequences to the user, with the possibility of choosing the musical items to be transmitted, to broadcast its own advertizing and promotional messages, and also to make public announcements, with the desired frequency and duration.

Another purpose of the invention is to achieve a method and an apparatus for the preparation and broadcasting of audio and/or visual sequences which allow to manage and update the sequences to be transmitted substantially automatically, without the user needing to devote time to such operations.

In accordance with these purposes, the method according to the invention provides that a service center prepares for each user, according to specific requests from the latter, a plurality of audio and/or visual documents in electronic format and transmits them telematically to said user so that it can broadcast them by means of its own broadcasting systems, according to an agreed sequential pattern.

In a preferential embodiment, the service center comprises at least a service processor able to transmit, through a telecommunication network, for example the Internet, said audio and/or visual documents to a plurality of terminals, each associated with a relative user.

According to, a first embodiment of the invention, each terminal is set with configuration parameters relating to times and methods of broadcasting the audio and/or visual documents; once the documents have been acquired, and based on said parameters, the terminal determines the sequence with which the documents are to be broadcast, after which it manages the broadcasting thereof.

According to another embodiment, the sequence is determined by the service center according to parameters, supplied by the user, relating to the times and methods in which the documents are to be broadcast.

According to a characteristic feature of the invention, each terminal is periodically and automatically connected to the service processor, in order to acquire possible updating elements therefrom to compose the sequence in which the documents are to be broadcast.

According to a variant, during this connection, the terminal issues an auto-diagnostic report by means of which it supplies the service center with information relating to its state of functioning and to the parameters with which it is set; according to this report the service center, through the telecommunication network with which it is connected, is able to make any modifications or corrections which might be necessary.

According to the invention, if the user is, or is associated with, a commercial enterprise, the sequence of audio and/or visual documents is prepared so as to cover at least the entire opening hours of said commercial enterprise.

According to a variant, said sequence comprises a background program, for example consisting of a plurality of documents of a musical nature, and a plurality of communications of various kinds, such as advertizing messages, public announcements, time signals or similar, inherent to the user's specific activity.

In determining the sequence in which the documents are broadcast, the method according to the invention provides to transmit said communications following desired times and methods, according to the user's needs.

In a preferential embodiment, the time signals and public announcements are broadcast without interrupting the background program, whereas advertizing messages are always broadcast at the end of a document of the background program.

According to a variant, at least the advertizing messages are broadcast at a higher volume than that of the background program, with an increase in volume in the order of 20%, so that such messages are more audible.

### BRIEF DESCRIPTION OF THE DRAWINGS

These and other characteristics at the present invention will be apparent from the following description of a preferential form of embodiment, given as a non-restrictive example, with reference to the attached drawings wherein:

FIG. 1 shows schematically the apparatus for the preparation and broadcasting of audio and/or visual sequences according to the present invention;

FIG. 2 shows a flow chart relative to the method according to the invention;

FIG. 3 shows a flow chart of one step of the method according to the invention;

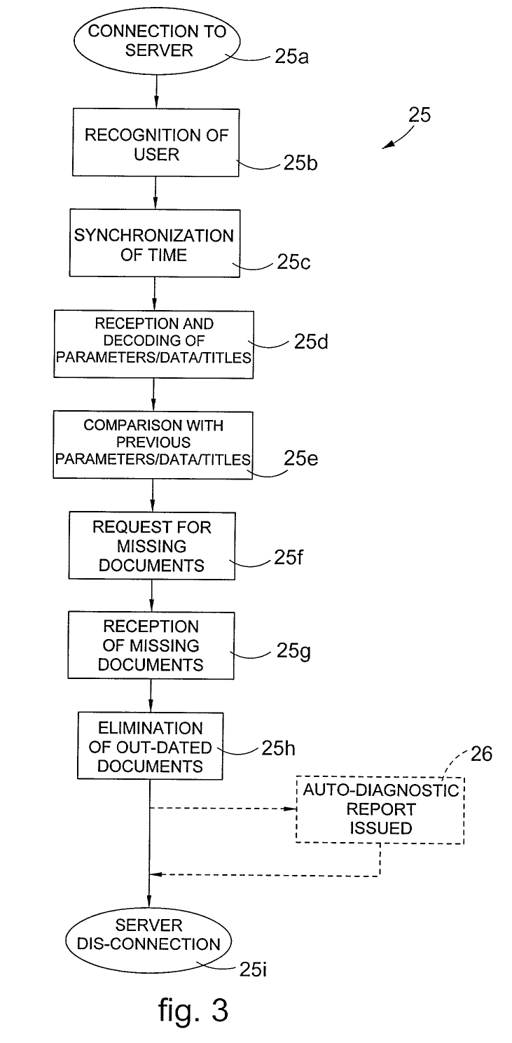

FIG. 4 shows a flow chart of another step of the method according to the invention.

### DETAILED DESCRIPTION OF A PREFERENTIAL FORM OF EMBODIMENT OF THE INVENTION

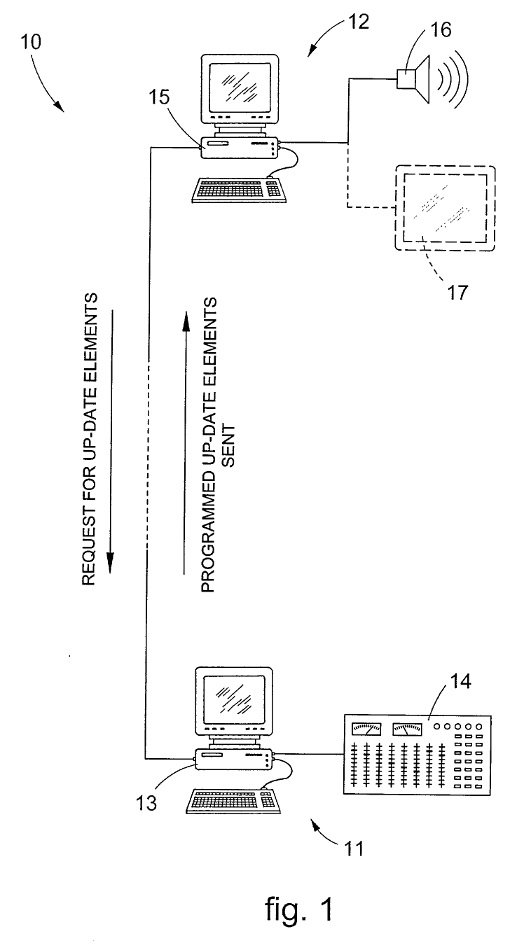

FIG. 1 shows schematically an apparatus 10 according to the present invention for the preparation and broadcasting of audio sequences such as musical items and/or communications of various types, by users 12, for example commercial enterprises.

Said apparatus 10 comprises a service center 11 and, in this case, a single user only, for the sake of simplicity.

The service center 11 comprises a service processor, or server, 13 and a unit 14 to record audio documents 14 in electronic format (files).

The user 12 is provided with a terminal 15 able to be connected to the server 13 by means of a telecommunication network, for example the Internet, and associated with an audio broadcasting system 16.

The service center 11 is able to provide the user 12 with personalized audio documents which the user 12 itself broadcasts during the opening hours or the commercial enterprise.

Said audio documents, in electronic format as we have said, for example of the type known by the acronym MP3, consist of musical items and voice communications of various types, such as advertizing messages, public announcements, time signals, etc.

According to the invention, the terminal 15 of the user 12 is first supplied with a list of audio documents, specifically prepared for the user 12, with a duration able to cover at least the opening hours of the commercial enterprise.

The terminal 15 is also configured, according to the user's requirements, with a series of parameters relating to the frequency and/or timetable at which the various voice communications (advertizing messages, public announcements, time signals, etc.) are broadcast.

According to a characteristic feature of the invention, it is provided that the terminal 15 connects automatically and periodically, for example once a day—outside the opening time of the commercial enterprise—with the server 13 in order to acquire possible up-dates relating to the configuration parameters and content of the list prepared for the user 12.

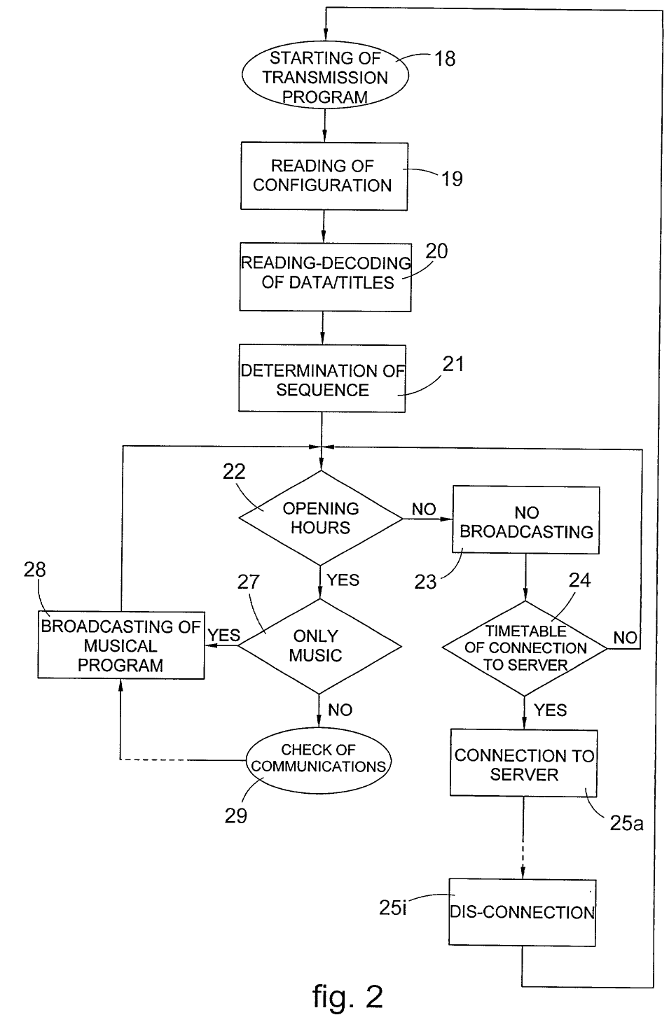

After the step 18 wherein the program of broadcasting the audio sequences is started, the terminal 15 first performs a step 19 to read the configuration parameters relating to the frequency/timetable at which the voice communications are broadcast, and subsequently a step 20 to read and decode the data and titles relating to the list of audio documents acquired. (FIG. 2).

According to these readings, a step 21 is then performed to determine the audio sequence, consisting of musical items and voice communications, which will be broadcast during the opening hours of the commercial enterprise.

Once said audio sequence has been determined, the terminal 15 performs a verification 22 to know if the current time is included in the opening hours of the commercial enterprise.

If not, a command of silence 23 is given so that no audio sequence is broadcast through the audio broadcasting system 16 and the terminal 15 performs a subsequent verification 24 to determine whether the current time coincides with the time it is connected to the server 13.

If so, the terminal 15 automatically performs an up-date step 25 in which it automatically makes the connection 25a with the server 13 in order to acquire the up-date elements necessary to determine the sequence, that is, the configuration parameters (instructions) relating to times and methods with which the sequence is to be broadcast, the data/titles of all the documents to be included in the sequence and the new documents to be implemented therein.

After the connection 25a, the up-date step 25 provides the following sub-steps:

recognition 25b of the user 12, by verification of the customer's personal codes by the server 13;

synchronization of the time 25c between the server 13 and the terminal 15;

reception and decoding 25d of the up-dated elements consisting of parameters/data/titles;

comparison 25e of the up-dated elements and the parameters/data/titles previously acquired;

request 25f for audio documents (musical items or communications) not previously acquired;

reception 25g of missing audio documents;

elimination 25h of out-dated audio documents.

Subsequently, the step of dis-connection 25i of the terminal 15 and the server 13 is performed and the step 18 of starting the transmission program is started again.

In this way new musical items, advertizing messages or communications of other types replace or are added to the audio documents included in the list in a completely automatic manner, without the user 12 needing to take any direct action.

According to a variant, before the dis-connection 25i with the server 13 occurs, the terminal 15 automatically issues an auto-diagnostic report 26 relating to its state of functioning and the configuration with which it is set; by means of this report the service center 11 is able to evaluate whether the setting and functioning of the terminal 15 are correct, possibly making the necessary modifications thereto through the telecommunication network.

If, after the step 21 wherein the audio sequence is determined, the terminal 15 has detected that the current time is included in the opening hours of the commercial enterprise, the terminal 15 continuously performs a step 27 to compare and control said audio sequence to verity whether it provides to broadcast only musical items or also voice communications.

In the first case (only musical items) the terminal 15 provides to start the musical program 28, successively broadcasting the chosen musical items which are transmitted through the audio broadcasting system 16.

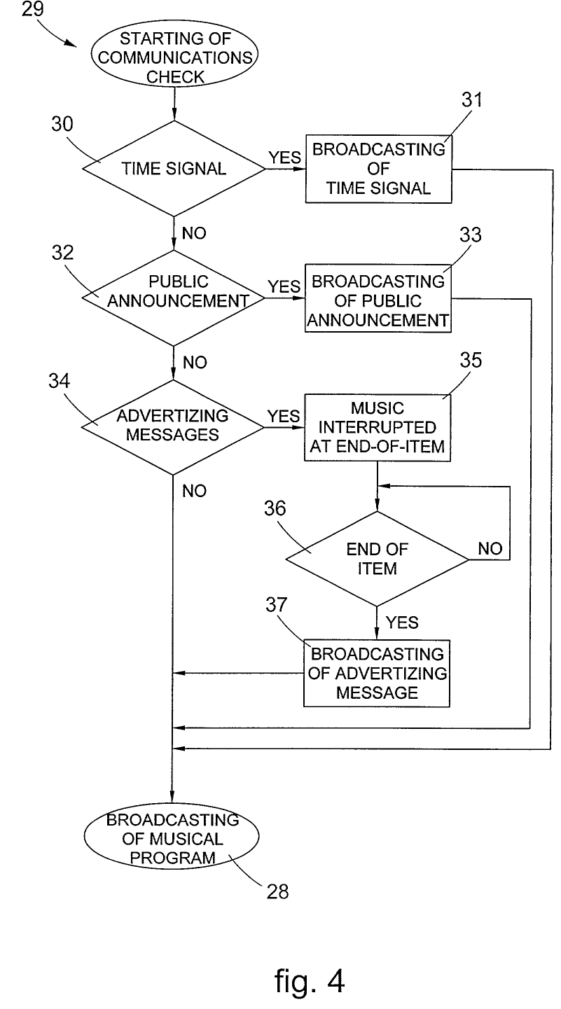

Otherwise, the terminal 15 performs a step 29 to check the voice communications (FIG. 4) during which, according to the configuration parameters with which it has been set, it verifies whether a specific voice communication is to be issued at that moment, or not.

To be more exact, it performs a first check 30 on the time signal and, if envisaged, it issues the signal 31 without interrupting the musical item in progress, which if necessary is only faded.

In the event that the time signal is not envisaged, a second check 32 is performed on possible public announcements.

In the event that one or more of said public announcements is envisaged, for example to announce that the commercial enterprise is about to close, the terminal carries out the broadcast 33 of said announcements, in this case too without interrupting the musical item in progress.

On the contrary, if no public announcement is envisaged, a third check 34 is made relating to advertizing messages.

If said third check 34 has a negative result, that is, if there are no advertising messages to be broadcast, the normal musical program 28 is continued whereas, otherwise, the terminal 15 gives the order to interrupt 35 the musical program at the end of the item in progress and begins a continuous check 36 to verify the end of said item.

At the end of the item in progress, one or more advertizing messages are broadcast 37 as envisaged by the audio sequence, and then the musical program 28 continues.

This process continues for the entire period of time during which the commercial enterprise remains open, at the end of which the terminal 15 gives the order to be silent 23.

In this way, the advertizing messages never interrupt the musical items and therefore on the one end they do not annoy the customers and on the other end they are clearer and more audible.

In a preferential embodiment of the invention, in order to make the advertizing messages even more audible, they are broadcast at a higher volume than that of the musical program, for example with an increase in volume of 20%.

According to a variant shown with a line of dashes in FIG. 1, the user 12 is also able to acquire and broadcast sequences of images during the opening hours of the commerical enterprise, by means of a video broadcasting system 17 to which the terminal 15 is connected.

In this case, the service center 11 is suitable to provide the user 12 not only with audio documents but also with documents of a visual type, consisting for example of photograms or films.

Modifications and/or additions of parts or steps may be made to the method and apparatus 10 as described heretofore, without departing from the field and scope of the present invention.

Moreover, although the present invention has been described with reference to specific examples, a person of skill in the art shall certainly be able to achieve many other equivalent forms of method and apparatus for the preparation and broadcasting of audio and/or visual sequences, all of which shall come within the field and scope of the present invention.

1. Method for the preparation and broadcasting of audio and/or visual sequences by a user (12), characterized in that it provides that a service center (11) prepares for said user (12), according to specific requests therefrom, a plurality of audio and/or visual documents in electronic format and transmits them telematically to said user (12) so that it can broadcast them by means of its own broadcasting systems (16, 17) according to a pre-set sequential pattern.

2. Method as in claim 1, characterized in that it provides to transmit said documents through a telecommunication network from a service processor (13) of said service center (11) to a terminal (15) associated with said user (12).

3. Method as in claim 2, characterized in that it provides to set said terminal (15) with configuration parameters relating to times and methods of broadcasting said documents by said user (12).

4. Method as in claim 2 and 3, wherein said documents are identified by means of data/titles supplied to said terminal (15), characterized in that it provides that said terminal (15), after receiving said documents, performs at least the following steps of:
reading the configuration parameters relating to times and methods of broadcasting (19);
reading the data/titles of said documents (20);
determining the sequence in which said documents are broadcast (21);
progressive broadcasting of said documents according to said sequence and according to the set times and methods.

5. Method as in claim 1 or 2, characterized in that it provides that said service center (11) prepares the sequence in which said documents are broadcast according to configuration parameters relating to broadcasting times and methods supplied by said user (12).

6. Method as in claim 4 or 5, characterized in that it periodically provides an up-date step (25) wherein said terminal (15) automatically connects to said service processor (13) to acquire therefrom possible up-date elements to compose said broadcasting sequence.

7. Method as in claim 6, characterized in that said up-date elements comprise at least the configuration parameters relating to times and methods of broadcasting the sequence, the data/titles of all the documents to be included in said sequence and the new documents to be implemented in said sequence.

8. Method as in claim 6 and 7, characterized in that said up-date step (25) comprises at least the following substeps:
connection (25a) of said terminal (15) to said service processor (13);
recognition (25b) of the user (12);
synchronization of the time (25c) between the terminal (15) and the service processor (13);
reception and decoding (25d) of said up-date elements;
comparison (25e) of said up-date elements with the previously acquired parameters/data/titles;
request for possible missing documents (25f);
reception of possible missing documents (25g);
elimination of possible out-dated documents (25h);
dis-connection (25i) of said terminal (15) and said service processor (13).

9. Method as in claim 8, characterized in that, before said dis-connection (25i), said terminal (15) issues an auto-diagnostic report (26) to supply said service center (11) with information relating to its state of functioning and to the configuration parameters with which it is set.

10. Method as in claim 9, characterized in that, according to said auto-diagnostic report (26), said service center (11) is able to perform, through the telecommunication network with which it is connected, possible modifications or corrections in order to restore the desired conditions of functioning and the configuration parameters envisaged for said terminal (15).

11. Method as in claim 4, wherein said user (12) is associated with a commercial enterprise where said audio and/or visual sequences are broadcast, characterized in that it provides that said terminal (15) is also configured with parameters relating to the opening hours of said commercial enterprise and that, after the step of determining the broadcasting sequence (21), it performs a step to check the time (22) so that the broadcasting of said sequences coincides with the opening hours of said commercial enterprise.

12. Method as in claim 11, wherein said audio and/or visual sequences comprise at least a background program, consisting of a plurality of audio and/or visual documents, and communications of various types, such as advertizing messages, public announcements, time signals or similar, characterized in that it provides that said terminal (15), after said step of checking the time (22), continuously performs a checking procedure on the sequence to be broadcast in order to determine the type of documents, relating to the background program or communication, to be transmitted during the opening hours of said commercial enterprise.

13. Method as in claim 12, characterized in that said checking procedure on the sequence to be broadcast comprises a step (29) to check said communications during which a verification (30, 32, 34) is made on the need to broadcast a time signal, a public announcement or an advertizing message, said needs, if confirmed, being satisfied by means of the broadcasting (31, 33, 37) of corresponding documents.

14. Method as in claim 12 or 13, characterized in that at least the broadcasting of said time signals and public announcements (31, 33) occurs without interrupting said background program.

15. Method as in any claim from 12 to 14 inclusive, characterized in that at least the broadcasting of said advertizing messages (37) is performed at the end of a document of said background program.

16. Method as in any claim from 12 to 15 inclusive, characterized in that at least the broadcasting of said advertizing messages (37) is performed at a higher volume than that of said background program (28).

17. Method as in claim 16, characterized in that at least the broadcasting of said advertizing messages (37) is performed at a volume higher by at least 20% than that of said background program (28).

18. Apparatus for the preparation and broadcasting of audio and/or visual sequences by a user (12), characterized in that it comprises at least a service center (11) provided with means (13, 14) able to prepare for said user (12), according to specific requests therefrom, a plurality of audio and/or visual documents in electronic format and to transmit said documents telematically to said user (12), said user (12) being provided with reception means (15) and broadcasting means (16, 17) able respectively at least to receive and to broadcast said documents according to a preset sequential pattern.

19. Apparatus as in claim 18, characterized in that said service center (11) comprises at least a recording unit (14) able to prepare said documents and a service processor (13) connected to a telecommunication network and that said reception means comprise at least a terminal (15) able to be connected to said service processor (13), by means of said telecommunication network, in order to acquire said documents.

20. Apparatus as in claim 19, characterized in that said terminal (15) is able to periodically and automatically connect to said service processor (13), through said telecommunication network.

21. Apparatus as in claim 19 or 20, characterized in that said telecommunication network is the Internet.
